(19) United States
(12) Patent Application Publication
(10) Pub. No.: US 2002/0001296 A1
(43) Pub. Date: Jan. 3, 2002

(54) Data transmission method for hybrid ARQ type II/III downlink of wide-band radio communication system

(76) Inventors: Yu-Ro Lee, Seoul (KR); Jae-Hong Park, Seoul (KR); Chong-Won Lee, Seoul (KR); Jeong-Hwa Ye, Seoul (KR)

Correspondence Address: BAKER & BOTTS, 30 ROCKEFELLER PLAZA, NEW YORK, NY, 10112

(21) Appl. No.: 09/832,249

(22) Filed: Apr. 10, 2001

(30) Foreign Application Priority Data
Apr. 10, 2000 (KR) 2000-18646
May 16, 2000 (KR) 2000-25966
Jun. 26, 2000 (KR) 2000-35455
Jun. 26, 2000 (KR) 2000-35456
Aug. 4, 2000 (KR) 2000-45165
Aug. 21, 2000 (KR) 2000-48435
Oct. 27, 2000 (KR) 2000-63612

(51) Int. Cl. H04Q 7/24

(52) U.S. Cl. 370/338; 455/451; 370/469

(57) ABSTRACT

A data processing method for a hybrid ARQ type II/III on a downlink of a wide-band radio communication system, wherein SRNC which is directly connected to a user equipment to allocate wireless resources to the user equipment and provides services by interlocking with a wireless communication core network in case of a call connection and CRNC which controls a sharing channel of a radio network are located on the different radio network includes the steps of: a) generating a RLC-PDU in a RLC layer of the SRNC and generating a part having RLC-PDU information needed for supporting the hybrid ARQ type II/III based on a header of the RLC-PDU (hereinafter, referred to as a HARQ-RLC-Control-PDU); b) transmitting the RLC-PDU and the HARQ-RLC-Control-PDU to MAC-D treating a general user part of a MAC layer through a logical channel; c) transmitting the RLC-PDU and the HARQ-RLC-Control-PDU of the MAC-D of the SRNC to MAC-C/SH treating common/shared channel part on the MAC layer of the CRNC; d) transforming the RLC-PDU and the HARQ-RLC-Control-PDU of the MAC-C/SH of the CRNC to a transmission block and transmitting it to a physical layer of a base station through a transport channel; and e) processing the transmission block to a radio transmission form in the physical layer of the base station and transmitting it to the base station through the physical layer.

### FIELD OF THE INVENTION

The present invention relates to a data processing method for hybrid automatic request for repeat (hereinafter, referred to as an ARQ) type II/III on a downlink of a wide-band radio communication system; and, more particularly, to a method for processing a radio link control—protocol data unit (RLC-PDU) and a HARQ-RLC-Control-PDU, which is extracted from the RLC-PDU, by using a transport channel such as a downlink shared channel (DSCH), wherein the RLC-PDU is used in W-CDMA based on a next generation mobile communication network, such as an international mobile telecommunication (IMT)—2000 and a universal mobile telecommunications system (UMTS), and to a computer readable recording media having program instructions for carrying out the method

### DESCRIPTION OF THE PRIOR ART

Terms used in this specification will be described.

“A radio network controller—radio link control (RNC—RLC)” is a radio link control protocol level entity of a radio network controller (RNC).

“A radio network controller—medium access control dedicated entity (RNC—MAC-D)” is a medium access control protocol level dedicated entity of a radio network controller (RNC).

“A radio network controller—medium access control common/shared entity (RNC—MAC-C/SH)” is a medium access control protocol level terminal common/shared entity of a radio network controller (RNC).

“Node B—L1” is a physical channel layer entity of a node B. The node B represents a base transceiver station (BTS) in an asynchronous IMT-2000 system. In this specification, the term node B is used the same as the term “base transceiver station” (BTS).

“User equipment—L1 (UE-L1)” is a physical channel layer entity of a user equipment (UE) (or a mobile station).

“User equipment—medium access control common/shared entity (UE—MAC-C/SH)” is a medium access control protocol level terminal common/shared entity of a user equipment (UE) (or a mobile station).

“User equipment—medium access control dedicated entity (UE—MAC-D)” is a medium access control protocol level terminal entity of a user equipment (UE) (or a mobile station).

“User equipment—radio link control (UE—RLC)” is a radio link control protocol level entity of a user equipment (UE) (or a mobile station).

“User equipment—radio resource control (UE—RRC)” is a radio resource control protocol level entity of a user equipment (UE) (or a mobile station).

“Iub” denotes an interface between the RNC and the Node B (BTS).

“Iur” denotes an interface between the RNC and another RNC.

“Uu” denotes an interface between the Node B and the UE.

“Logical channel” is a logical channel used for transmitting and receiving data between the RLC protocol entity and MAC protocol entity.

“Transport channel” is a logical channel used for transmitting and receiving data between the MAC protocol entity and a physical layer.

“Physical channel” is a practical channel used for transmitting and receiving data between a mobile station and a BTS.

When transporting the data from a radio network of a UMTS terrestrial radio access network (UTRAN) to the mobile station (MS), a Hybrid ARQ type I/II which has superior throughput than a Hybrid ARQ type I may be used.

FIG. 2 is a diagram showing a general wide-band radio communication network (W-CDMA). A UTRAN environment is used as an example in this drawing.

As described in FIG. 2, the UTRAN includes a user equipment (UE or MS) 10, an asynchronous radio network 20 and a radio communication core network 30, such as a GSM-MAP core network.

A Hybrid ARQ type II/III is provided between the UE and the asynchronous radio network 20. When a received data has an error, the receiver requests that the data be retransmitted by the transmitter.

A protocol stack structure in the above-referenced system is illustrated in FIG. 4.

FIG. 3 is a diagram showing a general UTRAN. In FIG. 3, the Iu is an interface between the radio communication core network 300 and the asynchronous radio network 200, and, the Iur means a logical interface between radio network controllers (RNC) of the asynchronous radio networks 200 and the Iub shows an interface between the RNC and each Node B. Uu designates a radio interface between the UTRAN and the UE.

Node B is a logical node, which is responsible for a radio transmission/receiving from one or more cells to the UE.

Generally in the UTRAN, if received data has an error, the receiver requests re-transmission of the data by the transmitter, using an automatic repeat request (ARQ) method. The ARQ methods are divided to ARQ type I, II and III, and technical characteristics of each type are described below.

The ARQ is an error control protocol, which automatically senses an error during transmission and then requests re-transmission of the error-containing block. That is, the ARQ is a data transmission error control method, and when an error is detected, automatically generates a re-transmission request signal.

The ARQ method is used in the UTRAN for a transmission packet data. The receiver requests the transmitter to re-transmit an error-generated containing packet. When using the ARQ method, if the number of re-transmit requests are increased, then throughput, which is amount of data being transmitted in a predetermined period, may be decreased. To solve the problem, the ARQ can be used along with a forward error correction coding (FEC) method, which is called as a hybrid ARQ.

The hybrid ARQ has three types I, II and III.

In case of type I, one coding rate is selected, for example, a coding rate is either no coding, rate ½ or rate ⅓ of convolutional coding, which is chosen according to channel environment or required quality of service (QoS), and the selected coding rate is continuously used. If there is a re-transmit request, the receiver removes pre-received data, and the transmitter re-transmits the data at the pre-transmitted coding rate. In this case, the coding rate is not changed according to changing channel environment, so, when compared with the type II and III the throughput may be decreased.

In case of type II ARQ, if the receiver requests data re-transmission, then the first received data is stored onto a buffer and the stored data is combined with the retransmitted data. That is, at first, the data is transmitted with a high coding rate, and in case of re-transmitting, the data is transmitted with a low coding rate and combined with the pre-received stored data to increase efficiency. For example, a convolutional coding rate ¼, which is a mother code, may generate coding rates 8/9, ⅔ or ¼ by puncturing and it is called a rate compatible punctured convolutional (RCPC) code. The RCPC code is illustrated FIG. 1.

A rate compatible punctured turbo (RCPT) code is obtained by puncturing a turbo code. Referring to FIG. 1, at first, data is transmitted with a coding rate of 8/9, and the original received version of the data is called ver(0), an error is detected in the data by checking a cyclic redundancy check (CRC) and the data is stored to a buffer, and retransmission is requested. The re-transmission is performed with a coding rate ⅔, and the re-transmission version is called ver(1).

The receiver combines the ver(0) data stored in the buffer and the ver(1) data. The combined data is decoded and checked by the CRC. The above-referenced process is repeated until an error is not detected. The last transmitted ver(n) is combined with a pre-transmitted ver(n−a)(0<a<n).

The type III ARQ is similar to the type II ARQ. It is different in that the re-transmitted ver(n) data is decoded before being combined with the ver(n−a) data, and checked by the CRC. If there is no error, the ver(n) data is transmitted to an upper layer. If an error is detected, the re-transmitted ver(n) data is combined with ver(n−a) and checked by the CRC to determine if further data re-transmission is necessary.

Accordingly, the hybrid ARQ type II/III is used for efficienct data transmission in the UTRAN.

The hybrid ARQ type II/III combines a first data which is encoded with a high coding rate, and a re-transmit data which is encoded with a low coding rate in the receiver to increase the throughput. Therefore, relational information between a sequence number and a re-transmitted version of a protocol data unit (PDU) is needed to be known in advance. The relation information should be transmitted with a low coding rate regardless of the re-transmission coding rate, thereby ensuring its quality of communication.

However, for the hybrid ARQ type II/III in the UTRAN, the data is transmitted with the high coding rate, thereby increasing the possibility of an error of a header of a RLC-PDU is increasing. Therefore, a method of stably transmitting the RLC-PDU header is required.

### SUMMARY OF THE INVENTION

It is, therefore, an object of the present invention to provide a data delivery method for hybrid ARQ type II/III on the downlink of wide-band radio communication system and a recording media for reading instructions for the method using a computer.

In accordance with an aspect of the present invention, there is provided a data processing method for a hybrid ARQ type II/III on a downlink of a wide-band radio communication system, wherein a serving radio network controller (hereinafter, referred to as a SRNC) which is directly connected to a user equipment to allocate wireless resources to the user equipment and provides services by interlocking with a wireless communication core network in case of a call connection and a controlling radio network controller (hereinafter, referred to as a CRNC) which controls a shared channel of a radio network, are located on different radio networks, comprising the steps of: a) generating a radio link control—protocol data unit (hereinafter, referred to as a RLC-PDU) in a radio link control (hereinafter, referred to as a RLC) layer of the SRNC, and generating a part having RLC-PDU information needed for supporting the hybrid ARQ type II/III based on a header of the RLC-PDU (hereinafter, referred to as a HARQ-RLC-Control-PDU); b) transmitting the RLC-PDU and the HARQ-RLC-Control-PDU to a medium access control dedicated (hereinafter, referred to as a MAC-D), which treats a general user part of a MAC layer through a logical channel; c) transmitting the RLC-PDU and the HARQ-RLC-Control-PDU from the MAC-D of the SRNC to a medium access control common/shared (hereinafter, referred to as a MAC-C/SH), which treats common/shared channel part on the MAC layer of the CRNC; d) transforming the RLC-PDU and the HARQ-RLC-Control-PDU in the MAC-C/SH of the CRNC to a transmission block and transmitting it to a physical layer of a base station through a transport channel; and e) processing the transmission block to a radio transmission form in the physical layer of the base station and transmitting it from the base station through the physical layer.

Also, the present invention may further comprising the step of: f) storing the RLC-PDU to a buffer, extracting the RLC-PDU stored in the buffer by using the HARQ-RLC-Control-PDU, decoding the extracted RLC-PDU and transmitting the RLC-PDU to an upper layer, then transmitting a response to the radio network.

In accordance with another aspect of the present invention, there is provided a computer readable data recording media for a hybrid ARQ type II/III on a downlink of a wide-band radio communication system, wherein a serving radio network controller (hereinafter, referred to as a SRNC) which is directly connected to a user equipment to allocate wireless resources to the user equipment and provides services by interlocking with a wireless communication core network in case of a call connection and a controlling radio network controller (hereinafter, referred to as a CRNC) which controls a shared channel of a radio network are located on different radio networks, comprising the functions of: a) generating a radio link control—protocol data unit (hereinafter, referred to as a RLC-PDU) in a radio link control (hereinafter, referred to as a RLC) layer of the SRNC, and generating a protocol data unit having RLC-PDU information needed for supporting the hybrid ARQ type II/III based on a header of the RLC-PDU (hereinafter, referred to as a HARQ-RLC-Control-PDU); b) transmitting the RLC-PDU and the HARQ-RLC-Control-PDU to a medium access control dedicated (hereinafter, referred to as a MAC-D), which treats a general user part of a MAC layer through a logical channel; c) transmitting the RLC-PDU and the HARQ-RLC-Control-PDU from the MAC-D of the SRNC to a medium access control common/shared (hereinafter, referred to as a MAC-C/SH), which treats common/shared channel part on the MAC layer of the CRNC; d) transforming the RLC-PDU and the HARQ-RLC-Control-PDU of the MAC-C/SH of the CRNC to a transmission block and transmitting it to a physical layer of a base station through a transport channel; and e) processing the transmission block to a radio transmission form in the physical layer of the base station and transmitting it from the base station through the physical layer.

Also, the present invention further comprising the function of: f) storing the RLC-PDU to a buffer, extracting the RLC-PDU stored in the buffer by using the HARQ-RLC-Control-PDU, decoding the extracted RLC-PDU and transmitting the RLC-PDU to an upper layer, then transmitting a response on the radio network.

The present invention is a method for realizing the hybrid ARQ type II/III on the downlink of an asynchronous mobile communication system which includes the CRNC and the SRNC, and may be adapted in a technical field where packet data service is used.

In an asynchronous communication system which has the CRNC and the SRNC on a different asynchronous network, the present invention which uses the hybrid ARQ type II/III may increase system efficiency by combining a changeable coding rate, a pre-transmitted data and a re-transmitted data and can provide satisfying service quality.

To perform the combining on the hybrid ARQ type II/III, the receiver should have information concerning the current receiving RLC-PDU, and the information composing part of the RLC-PDU should be transmitted more stably than a transmitted data.

For the above, the present invention generates the HARQ-RLC-Control-PDU, referring to the RLC-PDU, wherein the HARQ-RLC-Control-PDU has information of the RLC-PDU which is used for supporting the hybrid ARQ type II/III. At this time, the HARQ-RLC-Control-PDU includes sequence number of the RLC-PDU and a version number.

The RLC-PDU and the HARQ-RLC-Control-PDU are transmitted from a RLC protocol entity to a MAC-D protocol entity by using one or more logical channels and transmitted from the MAC protocol entity to the physical layer by using one or two transport channel of same type. Also, The RLC-PDU and the HARQ-RLC-Control-PDU are transmitted from a transmitting part to a receiver by using one or two physical channels of the same type.

According to the present invention, a HARQ-RLC-Control-PDU encoding process with low coding rate can reduce errors in packets, which may include the RLC-PDU information. Also the RLC-PDU information has no need to be known in advance for combining because the receiver first stores the received RLC-PDU in a buffer and determines the data processing method for the stored data after checking the HARQ-RLC-Control-PDU.

### BRIEF DESCRIPTION OF THE DRAWING

Other objects and aspects of the invention will become apparent from the following description of the embodiments with reference to the accompanying drawings, in which:

FIG. 1 is a diagram illustrating a general RCPC or RCPT code;

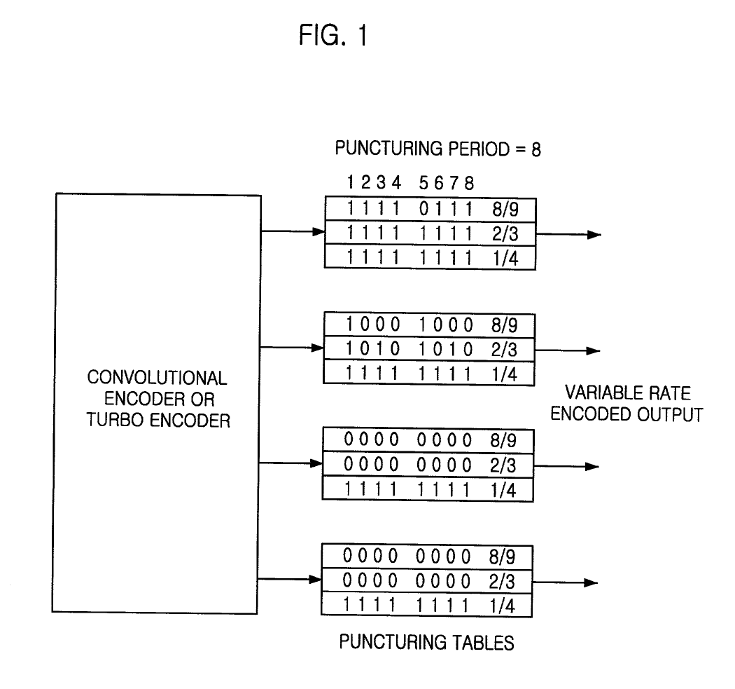

FIG. 2 is a diagram showing a general W-CDMA network;

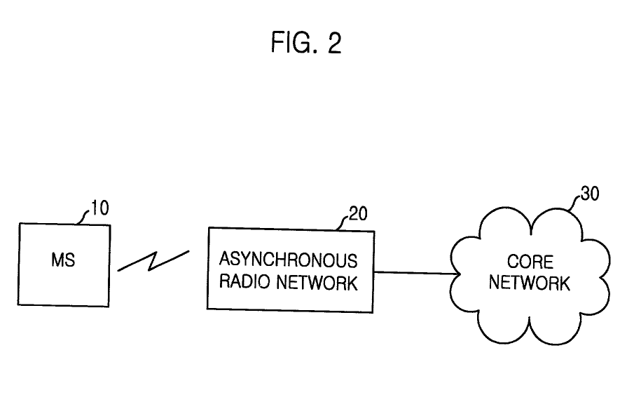

FIG. 3 is a diagram showing a general UTRAN;

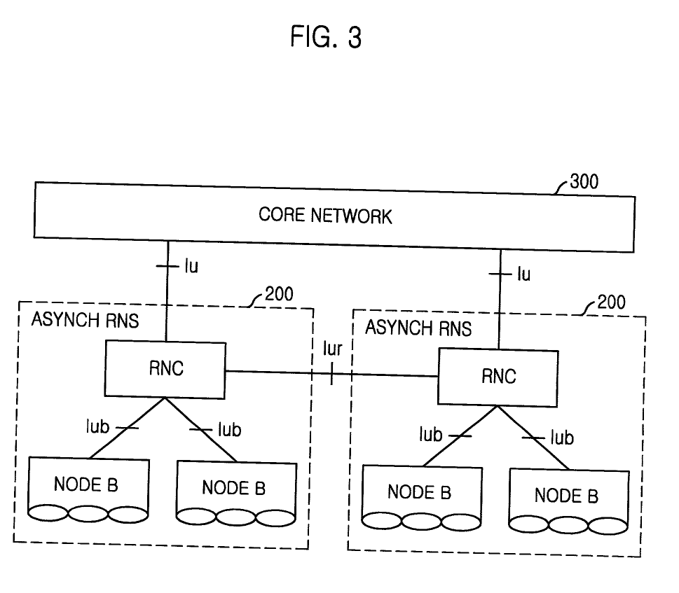

FIG. 4 is a diagram showing protocol stacks in UTRAN;

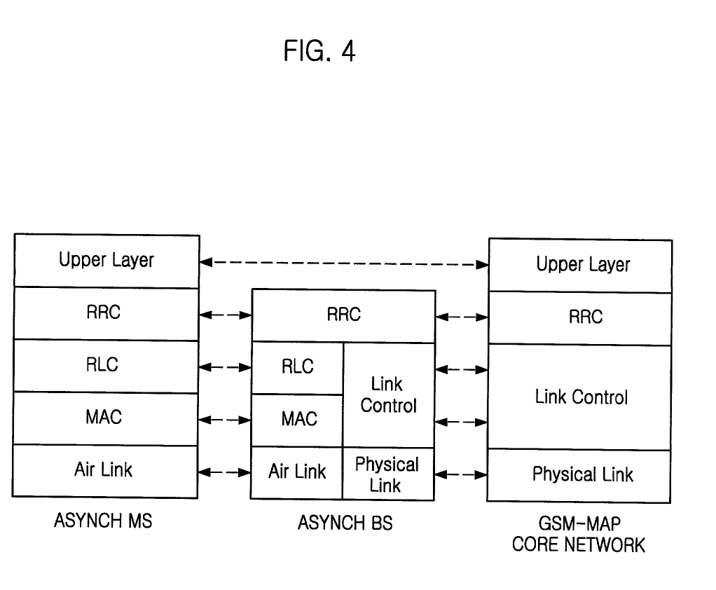

FIG. 5A is a diagram showing a UTRAN when RNC has both of SRNC and CRNC function in accordance with the present invention;

FIG. 5B is a diagram showing UTRAN when RNC has CRNC function and other RNC has SRNC function in accordance with the present invention;

FIG. 6 is a diagram showing relations among conventional RLC-PU, RLC-PDU, MAC-PDU and transport block;

FIG. 7 is a diagram showing a data process method of a transmitting part in accordance with the present invention;

FIG. 8 is a diagram showing a data processing method of a receiver in accordance with the present invention;

FIG. 9 is a flowchart showing a data processing method in accordance with the present invention; and

FIG. 10 is a flow chart showing a data transmission method in case of using a relation indicator in accordance with the present invention.

### DETAILED DESCRIPTION OF PREFERRED EMBODIMENTS

Hereinafter, a data processing method for hybrid ARQ type II/III downlink of a wide-band radio communication system according to the present invention will be described in detail referring to the accompanying drawings.

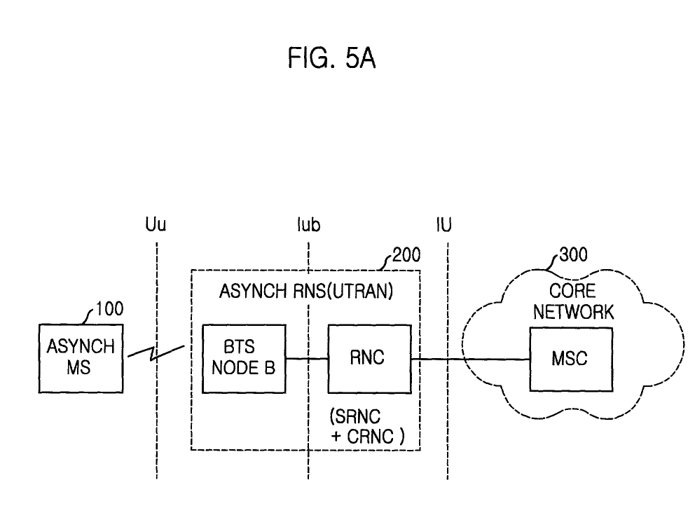

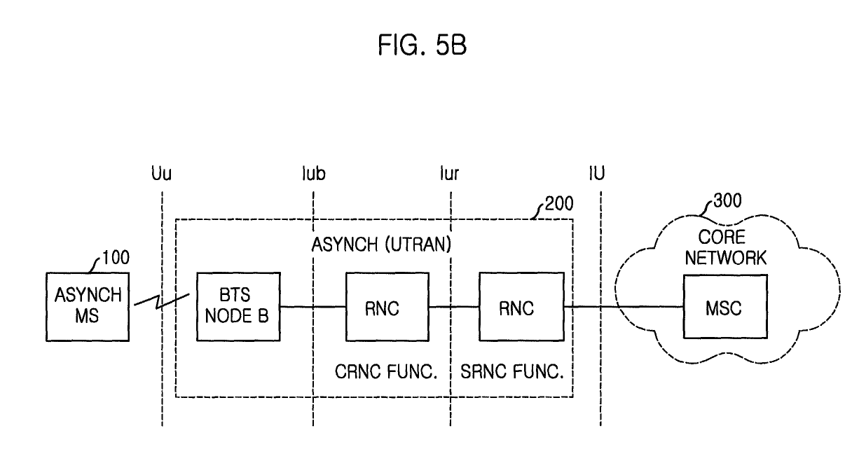

Referring to FIG. 5, an asynchronous mobile communication system having an interlocking structure is described. Under the interlocking structure, a UMS terrestrial radio access network (UTRAN) 200 may have one or more radio network controller (RNC). The RNC can perform a serving radio network controller (SRNC) function, a controlling radio network controller (CRNC) function or both functions.

The SRNC function is directly connected to a mobile station 100 and allocates radio resources to the mobile station 100, and in case of call connecting, the RNC interlocks with a radio communication core network 300 to provide service to the mobile station 100. Only one CRNC function exists in the whole UTRAN 200 and the CRNC is a kind of RNC that controls a logical channel over the whole UTRAN 200.

Referring to FIGS. 5A and 5B, the interlocking structure and the logical interface are illustrated, in case where one RNC performs both of the SRNC and the CRNC functions, and in a second case where one RNC performs the CRNC function and another RNC performs the SRNC function, respectively.

The present invention is for the hybrid ARQ type II/III method in which there is one RNC having the CRNC function and another of the RNC which has the SRNC function in the UTRAN 200 and uses a transport channel, such as a downlink shared channel (DSCH), in an interlocking structure as FIG. 5B.

That is, as a preferred embodiment, the present embodiment assumes the CRNC and the SRNC exists on the same asynchronous radio network.

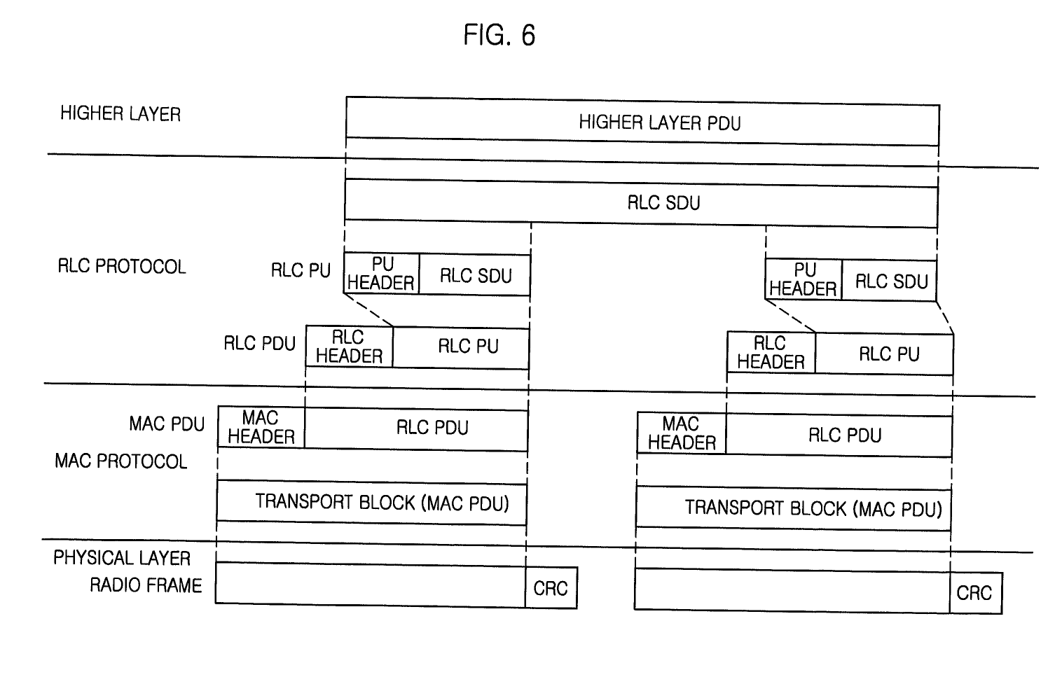

FIG. 6 is a diagram showing relations among conventional RLC-PU, RLC-PDU, MAC-PDU and a transport block.

As described in FIG. 6, a RLC-PDU includes one or more RLC-PU and the RLC-PDU is mapped into the MAC-PDU. The MAC-PDU is mapped to a transport block of a physical layer, and then CRC is added thereto.

In the physical layer of a transmitter, a data is transmitted through an encoding unit, a rate matching unit, an interleaver and a modulating unit. In the receiver, the CRC of the data is checked after passing through a demodulating unit, a deinterleaver, and a decoding unit to determine whether an error exists. If an error exists in the data, the receiver requests re-transmission of the data and stores the error-containing data in a buffer. At this time, the re-transmitted RLC-PDU is combined with the error-generated RLC-PDU to carry out a decoding, and then the CRC is checked. In this case, the sequence number and the version of currently received RLC-PDU should be known to carry out combining.

Also, the hybrid ARQ type II/III may increase error generation possibilities in the header of the RLC-PDU because it transmits with a high coding rate in an initializing transmission.

To solve the problem, the HARQ-RLC-Control-PDU, which has the header information, is generated from the RLC-PDU and the HARQ-RLC-Control-PDU is transmitted with the RLC-PDU. That is, a RLC protocol entity generates the RLC-PDU and organizes the HARQ-RLC-Control-PDU referring to the header information.

The RLC protocol entity transmits the RLC-PDU and the HARQ-RLC-Control-PDU to a MAC protocol entity. At this time, different or same type of logical channel can be used.

In case of using the different type of the logical channel, the RLC-PDU and the HARQ-RLC-Control-PDU use a logical channel, such as a dedicated traffic channel (DTCH) and a dedicated control channel (DCCH), respectively, and MAC-Data-REQ is used as a primitive.

In case of using the same type of the logical channel, the RLC-PDU and the HARQ-RLC-Control-PDU use a logical channel such as DTCH and the MAC-Data-REQ is used as a primitive.

The MAC protocol entity transmits the received RLC-PDU and the HARQ-RLC-Control-PDU to the physical layer after it transforms each of them to a transport block. At this time, one transport channel is used and MAC-PDU (including RLC-PDU) a and the MAC-PDU (including Control-RLC-PDU) b which are transmission blocks transformed from the RLC-PDU and the HARQ-RLC-Control-PDU, respectively, are transformed to a transport channel, such as the DSCH, and PHY-Data-REQ is used as a primitive. At this time, the PHY-Data-REQ primitive can be used to the MAC-PDU a and the MAC-PDU b, respectively, and the MAC-PDU a and the MAC-PDU b can be transmitted to the physical layer by using one PHY-Data-REQ primitive.

The physical layer transforms the received MAC-PDU a and the MAC-PDU b to a 10 ms radio frame through an encoding unit, a rate matching unit, an interleaver and a modulation unit, then transmits the MAC-PDU a and the MAC-PDU b to a user equipment (UE). At this time, one physical channel is used and the MAC-PDU a and the MAC-PDU b are transformed to the 10 ms radio frame and transmitted to the user equipment by using a physical channel, such as PDSCH.

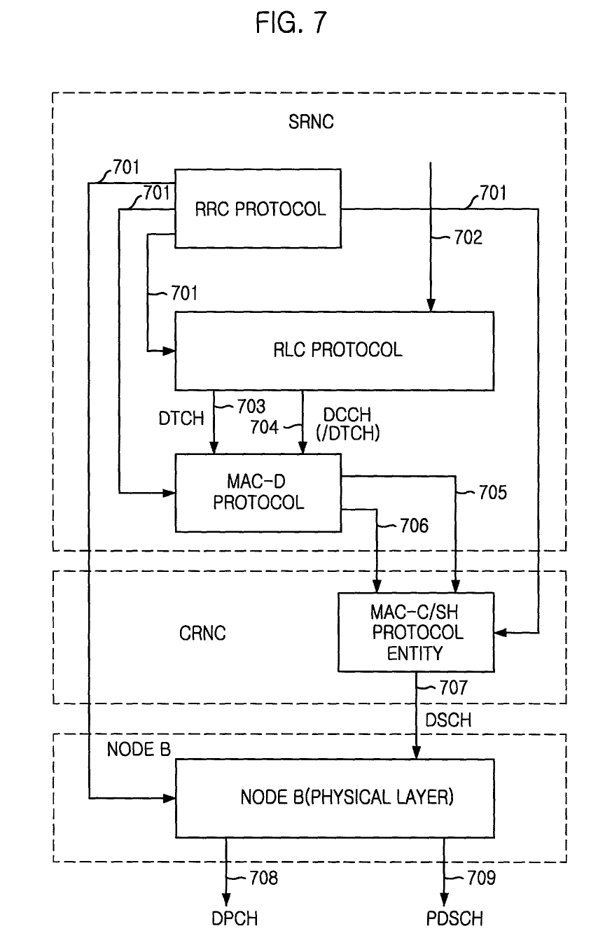

FIG. 7 is a diagram showing a data processing method on a transmitting part in accordance with the present invention.

As described in FIG. 7, a RLC protocol entity, a MAC-D protocol entity, a MAC-C/SH protocol entity and a physical entity are initialized at step 701 by a RRC protocol entity.

The RLC protocol receives data, which is to be transmitted to the receiver, from an upper layer at step 702. The RLC protocol entity converts the received data to RLC-PDU and generates HARQ-RLC-Control-PDU used for the hybrid ARQ type II/III based on header information of the RLC-PDU. The RLC protocol entity transmits the RLC-PDU and the HARQ-RLC-Control-PDU to the MAC-D protocol entity through a different or the same logical channel at steps 703 and 704.

In case of using different types of logical channels, the RLC protocol entity transmits the RLC-PDU to the MAC-D protocol entity of the SRNC through a logical channel, such as the DTCH at step 703 and the HARQ-RLC-Control-PDU is transmitted to the MAC-D protocol entity of the SRNC through a logical channel, such as the DCCH at step 704.

Meanwhile, in case of using the same type of logical channel, the RLC protocol entity transmits the RLC-PDU and the HARQ-RLC-Control-PDU to the MAC-D protocol entity of the SRNC through a logical channel, such as the DTCH at steps 703 and 704.

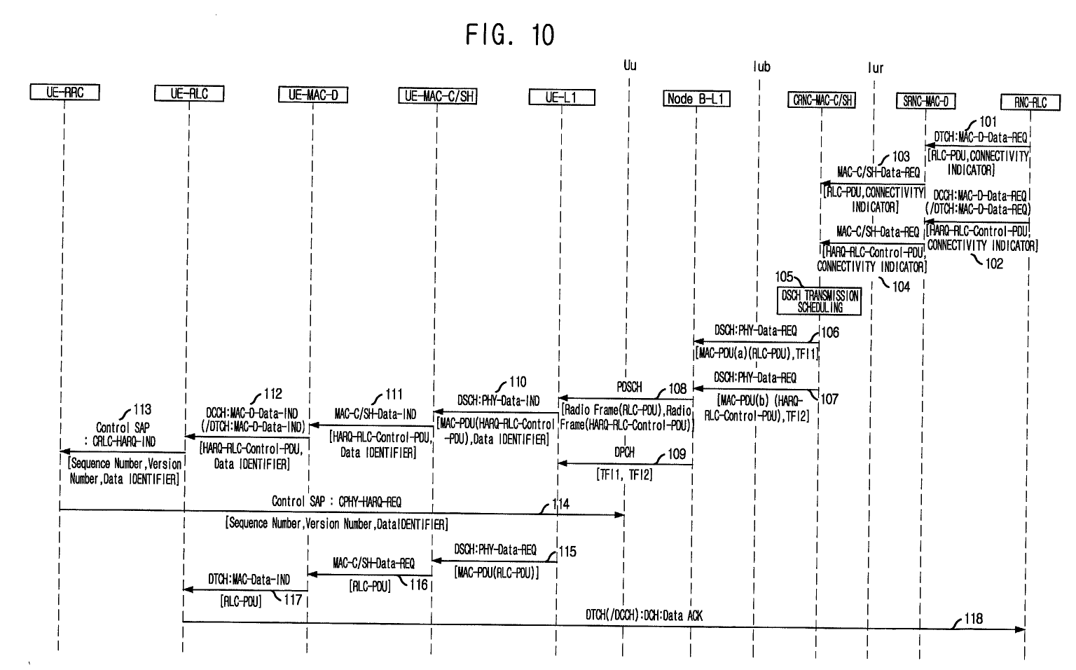

In this specification, for easy description, there is described a transmission process of the RLC-PDU and the HARQ-RLC-Control-PDU generated from the RLC protocol entity, and transmitted to the MAC-D protocol entity of the SRNC through different logical channels. In the RLC-protocol entity operation, a relation indicator is generated to maintain relation between the RLC-PDU and the HARQ-RLC-Control-PDU, and when the RLC-PDU and the HARQ-RLC-Control-PDU are transmitted, the relation indicator may be transmitted along with each PDU. The call process is described FIG. 10.

Next, the MAC-D protocol entity of the SRNC that receives the RLC-PDU and the HARQ-RLC-Control-PDU from the RLC protocol entity of the SRNC transmits them to the MAC-C/SH protocol entity at steps 705 and 706.

In here, the MAC-C/SH protocol entity of the CRNC, which receives the RLC-PDU and the HARQ-RLC-Control-PDU from the MAC-D protocol entity of the SRNC, transforms the RLC-PDU and the HARQ-RLC-Control-PDU to the MAC-PDU a and MAC-PDU b, respectively, then schedules the DSCH transport channel to transmits the transformed MAC-PDU a and MAC-PDU b through a transport channel, such as the DSCH. Then the MAC-PDU a and the MAC-PDU b is transmitted to the physical layer of the node B through the transport channel, such as the DSCH at step 707.

In here, if the MAC-C/SH protocol entity of the CRNC receives the relation indicator from the RLC protocol entity, wherein the relation indicator means relation of the RLC-PDU and the HARQ-RLC-Control-PDU, with each of the PDU, the MAC-C/SH protocol entity operates process 707 to the RLC-PDU and the HARQ-RLC-Control-PDU of same value.

After that, the physical layer of the node B which receives the MAC-PDU a and the MAC-PDU b carries out an encoding, a rate matching, an interleaving and a modulation to the MAC-PDU a and the MAC-PDU b, then transforms the MAC-PDU a and the MAC-PDU b to the 10 ms radio frame and transmits it to the receiver through a physical channel, such as PDSCH at step 709. At this time, the physical layer of the node B receives the TFI1 and the TFI2 of the MAC-PDU a and the MAC-PDU b from the MAC-C/SH protocol entity with each PDU then transmits the TFI1 and the TFI2 to the receiver through the physical channel, such as the DPCH at step 708.

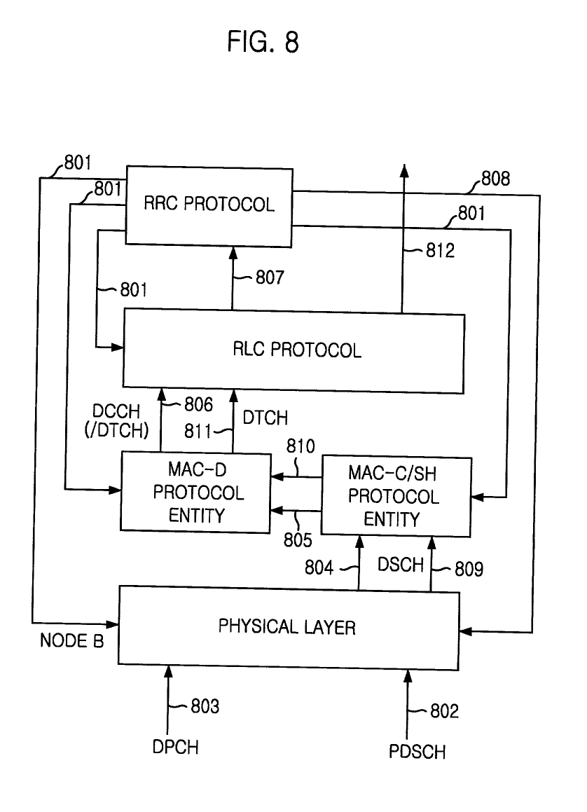

FIG. 8 is a diagram showing a data processing method of a receiver in accordance with the present invention.

As illustrated in FIG. 8, a RLC protocol entity, a MAC-D protocol entity, a MAC-C/SH protocol entity and a physical layer are initialized by a RRC protocol entity.

The physical layer of the receiver receives the 10 ms radio frame having the MAC-PDU a and the MAC-PDU b transmitted from the receiver through the physical channel, such as the PDSCH at step 802. The physical layer of the receiver receives the TFCI, which is essential information to carry out the physical layer operation to the RLC-PDU and the HARQ-RLC-Control-PDU at step 803.

Next, the physical layer of the receiver transforms the 10 ms radio frame having the TFI2 and the HARQ-RLC-Control-PDU between the TFI1 and the TFI2 received through the physical channel, such as the DPCH, to MAC-PDU through the demodulation, the deinterleaving and the decoding process, then transmits the MAC-PDU to the MAC-C/SH protocol entity by using a transport channel, such as the DSCH at step 804. At this time, the 10 ms radio frame having the received TFI1 and the RLC-PDU is stored to the buffer. After that, a data identifier is generated to identify the RLC-PDU stored in the buffer and transmits the data identifier with the transformed MAC-PDU to the MAC-C/SH protocol entity.

The MAC-C/SH protocol entity receives the MAC-PDU having the HARQ-RLC-Control-PDU, and the data identifier and transforms the MAC-PDU to the HARQ-RLC-Control-PDU then transmits the HARQ-RLC-Control-PDU and the data identifier to the MAC-D protocol entity at step 805.

Then, the MAC-D protocol entity, which receives the HARQ-RLC-Control-PDU and the data identifier from the MAC-C/SH protocol entity, transmits them to the RLC protocol entity by using the logical channel such as the DTCH, in case of using the same type of logical channel at step 806. At this time, in case of using the different type of logical channel, the HARQ-RLC-Control-PDU and the data identifier are transmitted to the RLC protocol entity by using the logical channel, such as the DCCH.

After that, the RLC protocol entity extracts a sequence number and a version number by interpreting the received HARQ-RLC-Control-PDU and transmits CRLC-HARQ-IND primitive, which has the sequence number, the version number and the data identifier as parameters, to the RRC protocol entity, through a control SAP at step 807.

Next, the RRC protocol entity transmits a CPHY-HARQ-REQ primitive of control SAP between RRC and L1 which receives the sequence number, the version number and the data identifier as a CRLC-HARQ-IND primitive through the control SAP between the RRC and the L1 to the physical layer at step 808.

The physical layer of the receiver extracts the 10 ms radio frame, which has the RLC-PDU stored in the buffer, and the TFI1 by using a received data identifier, then transforms the 10 ms radio frame to MAC-PDU through the demodulation, the deinterleaving and the decoding process by using the TFI1, the sequence number and the version number, and transmits the MAC-PDU to the MAC-C/SH protocol entity through the transport channel, such as the DSCH at step 809.

Subsequently, the MAC-C/SH protocol entity interprets the received MAC-PDU and transforms it to the RLC-PDU, then transmits the RLC-PDU to the MAC-D protocol entity at step 810.

The MAC-D protocol entity transmits the received RLC-PDU to the RLC protocol entity through the logical channel such as the DTCH at step 811. At this time, in case of using the same type of logical channel, the RLC-PDU is transmitted to the RLC protocol entity through the logical channel, such as the DTCH, which is the same channel with the HARQ-RLC-Control-PDU. In case of using the different type of logical channel, the RLC-PDU is transmitted to the RLC protocol entity through the logical channel, such as the DTCH, which is a different channel from the HARQ-RLC-Control-PDU.

The RLC protocol entity interprets the received RLC-PDU and transmits it to an upper layer at step 812.

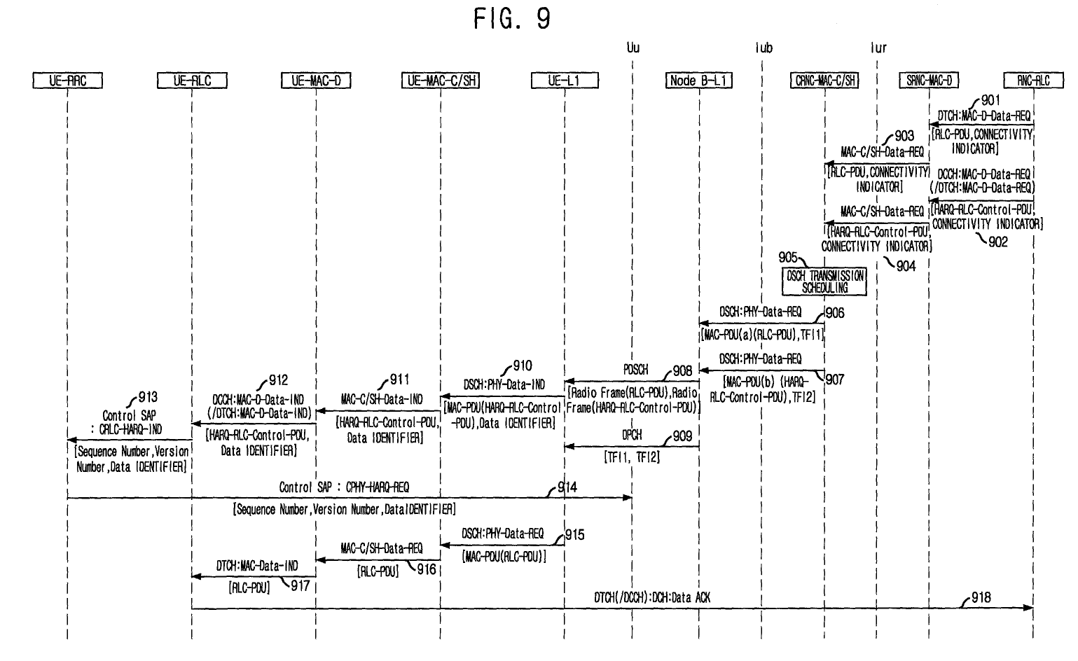

FIG. 9 is a flowchart showing a data processing method in accordance with the present invention.

First, SRNC-RLC, which receives data from the upper layer, transforms the received data to the RLC-PDU and transmits the RLC-PDU to RNC-MAC-D protocol entity through the logical channel (MAC-D-Data-REQ primitive), such as the DTCH at step 901.

The SRNC-RLC protocol entity generates the HARQ-RLC-Control-PDU by using information in a header of the RLC-PDU. At this time, the HARQ-RLC-Control-PDU includes a sequence number and a version number. The RNC-RLC protocol entity transmits the HARQ-RLC-Control-PDU to the RNC-MAC-D protocol entity through the logical channel (MAC-D-Data-REQ primitive), such as the DCCH at step 902.

In case of using the same type of logical channel, the SRNC-RLC protocol entity transmits the HARQ-RLC-Control-PDU to the SRNC-MAC-D protocol entity through the logical channel (MAC-D-Data-REQ primitive), such as the DTCH.

Next, the SRNC-MAC-D protocol entity that receives the RLC-PDU through the logical channel (MAC-D-Data-REQ primitive), such as the DTCH, transmits the RLC-PDU by using MAC-C/SH-Data-REQ primitive at step 903. At this time, the transmission type is a defined type in the Iur interface that defines an interface between the SRNC and the CRNC.

The SRNC-MAC-D protocol entity that receives the HARQ-RLC-Control-PDU through the logical channel (MAC-D-Data-REQ primitives), such as the DCCH, transmits the HARQ-RLC-Control-PDU protocol entity to CRNC-MAC-C/SH protocol entity by using the MAC-C/SH-Data-REQ primitive at step 904. At this time, the transmission type is a defined type in the Iur interface that defines an interface between the SRNC and the CRNC.

In case of using the same type of logical channel, the SRNC-MAC-D protocol entity that receives the HARQ-RLC-Control-PDU through the logical channel (MAC-D-Data-REQ primitive), such as the DTCH, transmits the HARQ-RLC-Control-PDU to the CRNC-MAC-C/SH protocol entity by using the MAC-C/SH-Data-REQ primitive. At this time, the transmission type is a defined type in the Iur interface that defines an interface between the SRNC and the CRNC.

Meanwhile, the CRNC-MAC-C/SH protocol entity carries out DSCH transmission scheduling to transmit the RLC-PDU and the HARQ-RLC-Control-PDU by the transport channel, such as the DSCH, and allocates TFL1 and TFI2 to the RLC-PDU and the HARQ-RLC-Control-PDU, respectively, then transforms the RLC-PDU and the HARQ-RLC-Control-PDU to the MAC-PDU at step 905. At this time, the MAC-PDU which transforms the RLC-PDU and the HARQ-RLC-Control-PDU are the MAC-PDU a and the MAC-PDU b, respectively.

The CRNC-MAC-C/SH protocol entity transmits the MAC-PDU a which has the RLC-PDU and the allocated TFI1 to the transport channel (PHY-Data-REQ primitive), such as the DSCH to the physical layer of the node B. At this time, the transmission type is defined an Iub interface that defines an interface between the RNC and the node B.

Also, the CRNC-MAC-C/SH protocol entity transmits the MAC-PDU b which has the HARQ-RLC-Control-PDU to the physical layer of the node B through the transport channel (PHY-Data-REQ primitive), such as the DSCH by using the allocated TFI1. At this time, the transmission form is defined as an Iub interface that defines an interface between the RNC and the node B.

After that, the physical layer of the node B transmits the MAC-PDU a and the MAC-PDU b which have the received RLC-PDU and the HARQ-RLC-Control-PDU, respectively to a user equipment (UE) after transforming them to the 10 ms radio frame through the coding, the interleaving and the modulation process 910 by using the physical channel, such as PDSCH at step 908.

The physical layer of the node B transmits the received TFI1 and the TFI2 through the physical channel, such as the DPCH at step 909.

UE-L1 of the receiver receives the 10 ms radio frame having the RLC-PDU and the HARQ-RLC-Control-PDU through the physical channel, such as the PDSCH, and receives the TFI1 and the TFI2 through the physical channel, such as the DPCH, then carries out the demodulating, the deinterleaving and the decoding process to the 10 ms radio frame having the TFI2 and the HARQ-RLC-Control-PDU to transform it to the MAC-PDU. The UE-L1 stores the 10 MS radio frame, which has the received TFI1 and the RLC-PDU, to the buffer and generates a data identifier to identify the 10 ms radio frame stored in the buffer. After that, the UE-L1 transmits the received MAC-PDU b and the data identifier to a UE-MAC-C/SH protocol entity through the transport channel (PHY-Data-IND primitive), such as the DSCH at step 910.

After that, the UE-MAC-C/SH protocol entity transmits the HARQ-RLC-Control-PDU and the data identifier to a UE-MAC-D protocol entity after transforming the received MAC-PDU to the HARQ-RLC-Control-PDU by using MAC-C/SH-Data-IND primitive at step 911.

The UE-MAC-D protocol entity transmits the HARQ-RLC-Control-PDU and the data identifier to a UE-RLC protocol entity through the logical channel (MAC-D-Data-IND primitive), such as the DCCH at step 912. At this time, in case of using same type of logical channel, the UE-MAC-D protocol entity transmits the HARQ-RLC-Control-PDU and the data identifier to the UE-RLC protocol entity through the logical channel (MAC-D-Data-IND primitive), such as the DTCH.

The UE-RLC protocol entity extracts a sequence number and a version number by interpreting the received HARQ-RLC-Control-PDU. Also, the LE-RLC protocol entity transmits the data identifier, the sequence number and the version number to a UE-RRC protocol entity as a primitive of CRLC-HARQ-IND, by using a control SAP defined between the UE-RLC and the UE-RRC at step 913.

After that, the UE-RRC protocol entity transmits CPHY-HARQ-REQ primitive, which has the received data identifier, the sequence number and the version number as a primitive parameter, to the UE-L1 by using a control SAP defined between the UE-L1 and the UE-RRC at step 914.

Subsequently, the UE-L1 extracts the 10 ms radio frame, which has the RLC-PDU stored in the buffer, and transforms the 10 ms radio frame through the demodulation, the deinterleaving and the decoding process by using the TFI1, the sequence number and the version number and transmits the MAC-PDU having the RLC-PDU to the UE-MAC-C/SH protocol entity by using the transport channel (PHY-Data-IND primitive), such as the DSCH at step 915.

The UE-MAC-C/SH protocol entity transmits the received RLC-PDU to the UE-MAC-D protocol entity by using MAC-C/SH-Data-IND after transforming the received MAC-PDU to the RLC-PDU at step 916.

Accordingly, the UE-MAC-D protocol entity transmits the received RLC-PDU to the UE-RLC protocol entity through the logical channel (MAC-D-Data-IND primitive), such as the DTCH at step 917.

Finally, the UE-RLC protocol entity interprets the received RLC-PDU and transmits it to an upper layer after transforming the RLC-PDU to the original data form, and then transforms a response to the SRNC-RLC protocol entity at step 918.

FIG. 10 is a flow chart showing a data transmission method in case of using a relation indicator in accordance with the present invention.

In here, the relation indicator means an indicator that denotes a relation relationship between the RLC-PDU and the HARQ-RLC-Control-PDU, which is generated based on the header part of the RLC-PDU. The relation indicator is added to the RLC-PDU and the HARQ-RLC-Control-PDU, and they have same value when they have the same relationship. By using the relation indicator, the CRNC-MAC-C/SH protocol entity can treat the related RLC-PDU and the HARQ-RLC-Control-PDU at the same time and with this, an effective operation of the hybrid ARQ type II/III is possible.

First, the SRNC-RLC, which receives data from the upper layer, make the received data to the RLC-PDU and generates the relation indicator which denotes an relationship with the HARQ-Control-RLC-PDU which is used in the RLC-PDU and the hybrid ARQ type II/III. The generated RLC-PDU and the relation indicator are transmitted to the SRNC-MAC-D protocol entity through the logical channel (MAC-D-Data-REQ primitive) by using DTCH at step 101.

After that, the SRNC-RLC protocol entity generates the HARQ-RLC-Control-PDU by using header part information of the RLC-PDU. At this time, the generated HARQ-RLC-Control-PDU includes sequence number and version number information. Subsequently, the SRNC-RLC protocol entity generates a relation indicator, which denotes a relationship between the RLC-PDU and the HARQ-RLC-Control-PDU which is used in the hybrid ARQ type II/III. The value of the relation indicator is same as the value of the relation indicator generated to the RLC-PDU at step 101. After that, the SRNC-RLC protocol entity transmits the generated HARQ-RLC-Control-PDU and the relation indicator to the SRNC-MAC-D protocol entity through the logical channel (MAC-D-Data-REQ primitive), such as the DCCH at step 102.

In here, in case of using the same type of logical channel, the SRNC-RLC protocol entity transmits the generated HARQ-RLC-Control-PDU and the relation indicator to the SRNC-MAC-D protocol entity by using the logical channel (MAC-D-Data-REQ primitive), such as the DTCH.

After that, the SRNC-MAC-D protocol entity, which receives the RLC-PDU and the relation indicator through the logical channel (MAC-D-Data-REQ primitive), such as the DTCH, transmits the RLC-PDU and the relation indicator to the CRNC-MAC-C/SH protocol entity by using MAC-C/SH-Data-REQ primitive at step 103. At this time, the transmission type is defined Iur interface that defines an interface between the SRNC and the CRNC.

The SRNC-MAC-D protocol entity, which receives the HARQ-RLC-Control-PDU and the relation indicator through the logical channel (MAC-D-Data-REQ primitive), such as the DCCH, transmits the HARQ-RLC-Control-PDU and the relation indicator to the CRNC-MAC-C/SH protocol entity by using the MAC-C/SH-Data-REQ primitive at step 104. At this time, the transmission type is defined an Iur interface that defines an interface between the SRNC and the CRNC.

In here, in case of using same type of logical channel, the SRNC-MAC-D protocol entity, which receives the HARQ-RLC-Control-PDU and the relation indicator through the logical channel (MAC-D-Data-REQ primitive), such as the DTCH, transmits the HARQ-RLC-Control-PDU and the relation indicator to the CRNC-MAC-C/SH protocol entity by using the MAC-C/SH-Data-REQ primitive. At this time, the transmission type is defined the Iur interface between the SRNC and the CRNC.

Meanwhile, the CRNC-MAC-C/SH protocol entity, which receives the RLC-PDU, the HARQ-RLC-Control-PDU and the relation indicator to each of the PDU, compares the relation indicator to each of the PDU and in case of having the different value, storing all the received data to the buffer. Then, compares with the data received from the SRNC-MAC-D protocol entity and in case of same, carries out the DSCH transmission scheduling to transmit the received RLC-PDU and the HARQ-RLC-Control-PDU through the transport channel, such as the DSCH and allocates the TFI1 and the TFI2 to the RLC-PDU and the HARQ-RLC-Control-PDU, respectively then transforms the RLC-PDU and the HARQ-RLC-Control-PDU to the MAC-PDU at step 105. At this time, the MAC-PDU which transforms the RLC-PDU and the HARQ-RLC-Control-PDU are the MAC-PDU a and the MAC-PDU b, respectively.

The CRNC-MAC-C/SH protocol entity transmits the MAC-PDU a which has the RLC-PDU and the allotted TFI1 to the physical layer of the node B through the transport channel (PHY-Data-REQ primitive), such as the DSCH. At this time, the transmission type is defined the Iub interface that defines an interface between the RNC and the node B.

Also, The CRNC-MAC—C/SH protocol entity transmits the MAC-PDU b which has the HARQ-RLC-Control-PDU and the allocated the TFI2 to the physical layer of the node B through the transport channel (PHY-Data-REQ primitive), such as the DSCH. At this time, the transmission type is defined the Iub interface that defines an interface between the RNC and the node B.

After that, the physical layer of the node B transforms the MAC-PDU a and the MAC-PDU b, which have the received RLC-PDU and the HARQ-RLC-Control-PDU, respectively, to the 10 ms radio frame through the coding, the interleaving and the modulation process, then transmits the 10 ms radio frame to the UE through the physical channel, such as the PDSCH at step 108.

The physical layer of the node B transmits the received TFI1 and TFI2 to the UE through the physical layer, such as the DPCH at step 109.

Then, the UE-L1 of the receiver receives the 10 ms radio frame, which has the RLC-PDU and the HARQ-RLC-Control-PDU, from node B-L1 through the physical channel, such as the PDSCH and receives the TFI1 and the TFI2 through the physical channel, such as the DPCH then, transforms the TFI2 and the 10 ms radio frame, which has the HARQ-RLC-Control-PDU, after carrying out the demodulation, the deinterleaving and the decoding process. After that, the UE-L1 transmits the MAC-PDU and the data identifier to the UE-MAC-C/SH protocol entity through the transport channel (PHY-Data-IND primitive), such as the DSCH at step 110.

The UE-MAC-C/SH protocol entity transforms the received MAC-PDU to the HARQ-RLC-Control-PDU and transmits the HARQ-RLC-Control-PDU and the data identifier to the UE-MAC-D protocol entity b using the MAC-C-/SH-Data-IND primitive at step 111.

Next, the UE-MAC-D protocol entity transmits the HARQ-RLC-Control-PDU and the data identifier to the UE-RLC protocol entity through the logical channel (MAC-D-Data-IND primitive), such as the DCCH at step 112. At this time, in case of using same type of logical channel, the UE-MAC-D protocol entity transmits the HARQ-RLC-Control-PDU and the data identifier to the UE-RLC protocol entity through the logical channel (MAC-D-Data-IND primitive), such as the DTCH.

Subsequently, the UE-RLC protocol entity extracts a sequence number and a version number by interpreting the received HARQ-RLC-Control-PDU. The data identifier, the sequence number and the version number are transmitted as a primitive of the CRLC-HARQ-IND to the UE-RRC protocol entity by using the control SAP which is defined between the UE-RLC and the UE-RRC at step 113.

The UE-RRC protocol entity transmits the CPHY-HARQ-REQ primitive having the sequence number and the version number as a parameter of the primitive, to the UE-L1 by using control SAP defined between the current UE-L1 and the UE-RRC 114.

After that, the UE-L1 extracts the 10 ms radio frame having the RLC-PDU stored in the buffer, and the TFI1 and transforms the 10 ms radio frame, which is extracted by using the TFI1, the sequence number and the version number, to the MAC-PDU through the demodulation, the deinterleaving and the decoding process then, transmits the MAC-PDU having the RLC-PDU to the UE-MAC-C/SH protocol entity through the transport channel (PHY-Data-IND primitive), such as the DSCH at step 115.

The UE-MAC-C/SH protocol entity interprets the received MAC-PDU and transforms it to the RLC-PDU then, transmits the RLC-PDU to the UE-MAC-D protocol entity by using the MAC-C/SH Data-IND at step 116.

The LE-MAC-D protocol entity transmits the received RLC-PDU to the UE-RLC protocol entity through the logical channel (MAC-D-Data-IND primitive), such as the DTCH at step 117.

Finally, the UE-RLC protocol entity interprets the received RLC-PDU to transform it to original data form and transmits it to the upper layer, then transmits a response to the SRNC-RLC protocol entity at step 118.

The effectiveness of the present invention is as below.

First, the present invention can regulate each of coding rate by constructing essential information between the data, e.g., a sequence number and a version number, etc. to the different PDU, such as the RLC-PDU and the HARQ-RLC-Control-PDU.

Second, the present invention can decrease an error-generating rate of the PDU that has essential information of the data by constructing essential information between the data, e.g., a sequence number and a version number, etc. to a different PDU.

Third, the present invention can carry out a data combining which is performed in the physical layer in case of realizing the hybrid ARQ type II/III, because it firstly checks the HARQ-RLC-Control-PDU between the RLC-PDU and the HARQ-RLC-Control-PDU.

Fourth, the present invention can use radio resource efficiently because it uses a transport channel such as DSCH and can reduce a time delay followed by a resource allocating operation.

Fifth, the present invention can reduce a time delay problem between Iur and Iub because it uses one transport channel.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

We claim:

1. A data processing method for a hybrid ARQ type II/III on a downlink of a wide-band radio communication system, wherein a serving radio network controller (hereinafter, referred to as a SRNC) which is directly connected to a user equipment to allocate wireless resources to the user equipment and provides services by interlocking with a wireless communication core network in case of a call connection and a controlling radio network controller (hereinafter, referred to as a CRNC) which controls a sharing channel of a radio network are located on the different radio network, comprising the steps of:
a) generating a radio link control—protocol data unit (hereinafter, referred to as a RLC-PDU) in a radio link control (hereinafter, referred to as a RLC) layer of the SRNC and generating a protocol data unit having RLC-PDU information needed for supporting the hybrid ARQ type II/III based on a header of the RLC-PDU (hereinafter, referred to as a HARQ-RLC-Control-PDU);
b) transmitting the RLC-PDU and the HARQ-RLC-Control-PDU to a medium access control dedicated (hereinafter, referred to as a MAC-D) treating a general user part of a MAC layer through a logical channel;
c) transmitting the RLC-PDU and the HARQ-RLC-Control-PDU of the MAC-D of the SRNC to a medium access control common/shared (hereinafter, referred to as a MAC-C/SH) treating common/shared channel part on the MAC layer of the CRNC;
d) transforming the RLC-PDU and the HARQ-RLC-Control-PDU of the MAC-C/SH of the CRNC to a transmission block and transmitting it to a physical layer of a base station through a transport channel; and
e) processing the transmission block to a radio transmission form in the physical layer of the base station and transmitting it to the base station through the physical layer.

2. The data processing as recited in claim 1, wherein the transmission block is a first MAC-PDU and a second MAC-PDU which include the RLC-PDU and the HARQ-RLC-Control-PDU, respectively.

3. The data processing method as recited in claim 2, wherein in the step e), at a physical layer of the base station, the transmission block is transmitted to the mobile station through a physical channel by processing to a radio transmission form, and a transport format indicator 1 (TFI1) and a transport format indicator 2 (TFI2) of the first and the second MAC-PDU, respectively, are added.

4. The data processing method as recited in claim 3, further comprising the step of: f) storing the RLC-PDU to a buffer, extracting the RLC-PDU stored in the buffer by using the HARQ-RLC-Control-PDU, decoding the extracted RLC-PDU and transmitting the RLC-PDU to an upper layer, then transmitting a response to the radio network

5. The data processing method as recited in claim 4, wherein the step f) includes the steps of:
f1) receiving a radio frame having the RLC-PDU and the HARQ-RLC-Control-PDU transmitted from the radio network through a physical channel, and receiving information required for performing a physical layer operation;
f2) transforming a radio frame, which has the TFI2 and the HARQ-ROC-Control-PDU, to the second MAC-PDU through the demodulation, the deinterleaving and the decoding process and transmitting it to a MAC-C/SH of the mobile station through a transport channel;
f3) in case of performing the step f2), storing a radio frame having the RLC-PDU to the buffer, generating a data identifier for identifying the RLC-PDU stored in the buffer and transmitting the data identifier and the second MAC-PDU to the MAC-C/SH of the mobile station;
f4) receiving the second MAC-PDU having the HARQ-RLC-Control-PDU, and a data identifier from the physical layer of the mobile station, transforming the second MAC-PDU to the HARQ-RLC-Control-PDU and transmitting the HARQ-RLC-Control-PDU and the data identifier to MAC-D of the mobile station;
f5) transmitting the HARQ-RLC-Control-PDU and the data identifier to the RLC layer of the mobile station through a logical channel;
f6) interpreting the received HARQ-RLC-Control-PDU to extract a sequence number and a version number and transmitting the sequence number, the version number and the data identifier to a radio resource control (RRC) layer of the mobile station;
f7) transmitting the sequence number, the version number and the data identifier to the physical layer of the mobile station;
f8) extracting a radio frame, which has the RLC-PDU stored in the buffer, and the TFI1, by using the data identifier, and by using the TFI1, the sequence number and the version number, transforming the extracted radio frame to MAC-PDU through the modulating, the deinterleaving and the decoding process, and then transmitting the radio frame to MAC-C/SH of the mobile station;
f9) transforming the MAC-PDU to the RLC-PDU, after interpreting the MAC-PDU by the MAC-C/SH of the UE, and transmitting the RLC-PDU to the MAC-D of the mobile station;
f10) transmitting the RLC-PDU to an RLC layer of the mobile station, through a logical channel; and
f11) transmitting the RLC-PDU which is received from RLC layer of the mobile station, after interpreting the RLC-PDU and transmitting a response to the radio network.

6. The data processing method as recited in claim 5, wherein in the step f6), the RLC layer of the mobile station interprets the received HARQ-RLC-Control-PDU and after extracting a sequence number and a version number, transmits the sequence number, the version number and the data identifier to an RRC layer of the through CRLC-HARQ-IND primitive.

7. The data processing method as recited in claim 5, wherein in the step f7), an RRC layer of the mobile station transmits the sequence number, the version number and the data identifier to the physical layer of the mobile station through a CPHY-HARQ-REQ primitive.

8. The data processing method as recited in claim 1, wherein the step d) includes the steps of:
d1) performing a transmission scheduling for transmitting the received RLC-PDU and the HARQ-RLC-Control-PDU;
d2) allocating the TFI1 and the TFI2 to the RLC-PDU and the HARQ-RLC-Control-PDU, respectively, and changing the RLC-PDU and the HARQ-RLC-Control-PDU to the first MAC-PDU and the second MAC-PDU, respectively; and
d3) transmitting the first and the second MAC-PDU and the allotted TFI1 and the TFI2 to the physical layer of the base transceiver station (BTS).

9. The data process methods for hybrid ARQ type II/III on a downlink of a wide-band radio communication system as recited in claim 8, wherein the step e) includes the steps of:
e1) transforming the first MAC-PDU and the second MAC-PDU which have the RLC-PDU and the HARQ-RLC-Control-PDU, respectively, to a radio frame through the coding, the interleaving and the modulating process, then transmitting the radio frame to a mobile station through the physical channel; and
e2) transmitting the received TFI1 and the TFI2 to the mobile station through the physical layer.

10. The data processing method as recited in claim 1, wherein the RLC layer of the SRNC generates a relation indicator which denotes a relationship between the RLC-PDU and the HARQ-RLC-Control-PDU, and transmitting the relation indicator, the RLC-PDU and the HARQ-RLC-Control-PDU with each PDU.

11. The data processing methods for hybrid ARQ type II/III on a downlink of a wide-band radio communication system as recited in claim 10, wherein the relation indicator is made for each of the RLC-PDU and the HARQ-RLC-Control-PDU which is generated based on a header part, and has the same value for related PDU's.

12. The data processing method as recited in claim 11, wherein MAC-C/SH of the CRNC treats related RLC-PDU and HARQ-RLC-Control-PDU, at the same time by using the relation indicator, when the relation indicator is received with each PDU through the MAC-D of the SRNC.

13. The data processing method as recited in claim 12, wherein the logical channel is a dedicated traffic channel (DTCH) logical channel for transmitting the RLC-PDU and the HARQ-RLC-Control-PDU.

14. The data processing method as recited in claim 12, wherein the logical channel includes the DTCH and a dedicated control channel (DCCH) logical channels for transmitting the RLC-PDU and the HARQ-RLC-Control-PDU, respectively.

15. The data processing method as recited in claim 12, wherein the transport channel is a downlink shared channel (DSCH) for transmitting the RLC-PDU and the HARQ-RLC-Control-PDU.

16. The data processing method as recited in claim 12, wherein the physical channel is PDSCH for transmitting the first and the second MAC-PDU and DPCH for transmitting the TFI1 and the TFI2.

17. The data processing method as recited in claim 12, wherein the radio network is an asynchronous radio network.

18. A computer readable data recording media having instructions for a data processing method for a hybrid ARQ type II/III on a downlink of a wide-band radio communication system, wherein a serving radio network controller (hereinafter, referred to as a SRNC) which is directly connected to a user equipment to allocate wireless resources to the user equipment and provides services by interlocking with a wireless communication core network in case of a call connection and a controlling radio network controller (hereinafter, referred to as a CRNC) which controls a sharing channel of a radio network are located on the different radio network, comprising the functions of:
a) generating a radio link control—protocol data unit (hereinafter, referred to as a RLC-PDU) in a radio link control (hereinafter, referred to as a RLC) layer of the SRNC and generating a protocol data unit having RLC-PDU information needed for supporting the hybrid ARQ type II/III based on a header of the RLC-PDU (hereinafter, referred to as a HARQ-RLC-Control-PDU);
b) transmitting the RLC-PDU and the HARQ-RLC-Control-PDU to a medium access control dedicated (hereinafter, referred to as a MAC-D) treating a general user part of a MAC layer through a logical channel;
c) transmitting the RLC-PDU and the HARQ-RLC-Control-PDU of the MAC-D of the SRNC to a medium access control common/shared (hereinafter, referred to as a MAC-C/SH) treating common/shared channel part on the MAC layer of the CRNC;
d) transforming the RLC-PDU and the HARQ-RLC-Control-PDU of the MAC-C/SH of the CRNC to a transmission block and transmitting it to a physical layer of a base station through a transport channel; and
e) processing the transmission block to a radio transmission form in the physical layer of the base station and transmitting it to the base station through the physical layer.

19. The computer readable data recording media as recited in claim 18, further comprising the function of: f) storing the RLC-PDU to a buffer, extracting the RLC-PDU stored in the buffer by using the HARQ-RLC-Control-PDU, decoding the extracted RLC-PDU and transmitting the RLC-PDU to an upper layer, then transmitting a response to the radio network

20. The computer readable data recording media as recited in claim 19, wherein the function f) comprises the functions of:
f1) receiving a radio frame having the RLC-PDU and the HARQ-RLC-Control-PDU transmitted from the radio network through a physical channel, and receiving information required for performing a physical layer operation;
f2) transforming a radio frame, which has the TFI2 and the HARQ-ROC-Control-PDU, to the second MAC-PDU through the demodulation, the deinterleaving and the decoding process and transmitting it to a MAC-C/SH of the user equipment (UE) through a transport channel;
f3) in case of performing the step f2), storing a radio frame having the RLC-PDU to a buffer, generating a data identifier for identifying the RLC-PDU stored in the buffer and transmitting the data identifier and the second MAC-PDU to the MAC-C/SH of the mobile station;
f4) receiving the second MAC-PDU, which has the HARQ-RLC-Control-PDU, and a data identifier from the physical layer of the mobile station, transforming the second MAC-PDU to the HARQ-RLC-Control-PDU and transmitting the HARQ-RLC-Control-PDU and the data identifier to MAC-D of the mobile station;
f5) transmitting the HARQ-RLC-Control-PDU and the data identifier to the RLC layer of the mobile station through a logical channel;
f6) interpreting the received HARQ-RLC-Control-PDU to extract a sequence number and a version number and transmitting the sequence number, the version number and the data identifier to a radio resource control (RRC) layer of the mobile station;
f7) transmitting the sequence number, the version number and the data identifier to the physical layer of the mobile station;
f8) extracting a radio frame, which has the RLC-PDU stored in the buffer, and the TFI1, by using the data identifier, and by using the TFI1, the sequence number and the version number, transforming the extracted radio frame to MAC-PDU through the modulation, the deinterleaving and the decoding process, and then transmitting the radio frame to MAC-C/SH of the mobile station;
f9) transforming the MAC-PDU to the RLC-PDU, after interpreting the MAC-PDU by the MAC-C/SH of the mobile station, and transmitting the RLC-PDU to the MAC-D of the mobile station;
f10) transmitting the RLC-PDU to an RLC layer of the mobile station, through a logical channel; and
f11) transmitting the RLC-PDU received from the RLC layer of the mobile station, after interpreting the RLC-PDU and transmitting the response to the radio network.
